(19) United States
(12) Patent Application Publication
(10) Pub. No.: US 2009/0135308 A1
(43) Pub. Date: May 28, 2009

(54) BROADCAST RECEIVING APPARATUS AND REMOTE CONTROLLER AND METHOD FOR SCANNING CHANNELS THEREOF

(75) Inventor: Jeong-a Cho, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/125,169

(22) Filed: May 22, 2008

(30) Foreign Application Priority Data
Nov. 22, 2007 (KR) 10-2007-0119842

(51) Int. Cl. H04N 5/50; H04N 5/44

(52) U.S. Cl. 348/731; 348/734

(57) ABSTRACT

A broadcast receiving apparatus and a method for scanning channels thereof are disclosed. The broadcast receiving apparatus receives a user command transmitted from a remote controller having a scan key, sets an interval between channels according to a time period in which a scan key is depressed, and scans the channels. Accordingly, a channel scanning is fast and conveniently performed, and thus a user selects a desired channel.

### CROSS-REFERENCE TO RELATED APPLICATIONS

This application claims priority under 35 U.S.C. §119 from Korean Patent Application No. 10-2007-0119842, filed on Nov. 22, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to a broadcast receiving apparatus and a remote controller, and a method for scanning channels thereof, and more particularly, to a broadcast receiving apparatus which efficiently scans channels using a remote controller, and a method for scanning channels thereof.

2. Description of the Related Art

With a related art broadcast receiving apparatus, a user searches a desired channel by manipulating channel conversion keys (▴, ▾) or numeric keys, or scans all channels receivable by the broadcast receiving apparatus using an automatic channel search function and then selects a desired channel. As the broadcast industry has introduced advanced technologies such as cable broadcasting, satellite broadcasting, and digital multimedia broadcasting (DMB), more channels have been made available for use of broadcast viewers. However, an increased amount of time is required for a user to search a desired channel using related art methods.

Specifically, a portable mobile broadcast receiving apparatus generally does not employ numeric keys to simplify an appearance of a remote controller, so a user should use channel conversion keys (▴, ▾) to search a desired channel. Therefore, a method is required, which efficiently searches a channel and is applicable to a mobile broadcast receiving apparatus.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a broadcast receiving apparatus and remote controller in which the manipulation of the remote controller is simplified, and a channel interval is adjusted so that a channel scanning is fast and conveniently performed, and a method for scanning channels thereof

According to an exemplary aspect of the present invention, there is provided a broadcast receiving apparatus, comprising a reception unit which receives a user command transmitted from a remote controller composed exclusively of a plurality of function keys; and a control unit which counts a time period in which a key signal corresponding to a predetermined key of the function keys is received through the reception unit, and scans the channels based on the counted time period.

The control unit may set a digit corresponding to the counted time period to be a channel scan interval to scan the channels.

The control unit may search the channels each having a last digit corresponding to the counted time period.

The apparatus may further comprise an on screen display (OSD) generator which generates an OSD menu to display the time period in which the key signal is received through the reception unit.

The predetermined key may be a scan key to receive a channel scan command.

The control unit may count the time period in which the key signal is received through the reception unit, and if a predetermined command is input through the remote controller, scan the channels according to the counted time period.

According to an exemplary aspect of the present invention, there is provided a method for scanning channels, comprising receiving a key signal corresponding to a predetermined key from a remote controller composed exclusively of a plurality of function keys; and counting a time period in which the key signal is received, and scanning channels based on the counted time period.

The scanning may set a digit corresponding to the counted time period to be the channel scan interval to scan the channels.

The scanning may further comprise searching channels having a last digit corresponding to the counted time period.

The method may further comprise displaying one of the time period in which the key signal is received, and a digit corresponding to the time period in which the key signal is received.

The method may further comprise storing a table which is used to search the channels, wherein the digit corresponding to the counted time period is stored in the table, corresponding to the channel scan interval to search the channels or the last digit of channel numbers to be searched.

The predetermined key may be a scan key to receive a channel scan command.

The method may further comprise scanning the channels, if a predetermined command is input through the remote controller.

The method may further comprise scanning the channels in an ascending sequence according to the channel scan interval if the predetermined command is input through an up key of the remote controller; and scanning the channels in a descending sequence according to the channel scan interval if the predetermined command is input through a down key of the remote controller.

According to another exemplary aspect of the present invention, there is provided a method for scanning channels of a broadcast receiving apparatus using a remote control having no numeric key, the method comprising, counting a time period in which a predetermined key is depressed; and selecting a channel to be changed according to a digit corresponding to the counted time period.

The selecting may select a channel to be changed, if the channel is above or under a current channel by an interval based on the digit corresponding to the counted time period.

The selecting may select a channel to be changed, among channels from which a broadcast signal is detected, if the channel is above or under a current channel by an interval based on the digit corresponding to the counted time period.

The selecting may select a channel to be changed, if the channel is a last digit that corresponds to the counted time period, and is the nearest channel to the current channel.

According to an aspect of the present invention, if the predetermined key is pressed twice, the channel scan mode is completed.

According to an exemplary aspect of the present invention, there is provided a method for scanning channels, comprising receiving a key signal from a remote controller; and counting a time period in which the key signal is received, and scanning the channels based on the counted period.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating a broadcast receiving apparatus according to an exemplary embodiment of the present invention;

FIG. 2A is a view illustrating a remote controller according to an exemplary embodiment of the present invention;

FIG. 2B is a block diagram illustrating an inner structure of a remote controller according to an exemplary embodiment of the present invention;

FIGS. 3A and 3B are views illustrating a message displayed on a broadcast receiving apparatus according to an exemplary embodiment of the present invention; and

FIG. 4 is a flowchart provided to explain the operation of a broadcast receiving apparatus according to an exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

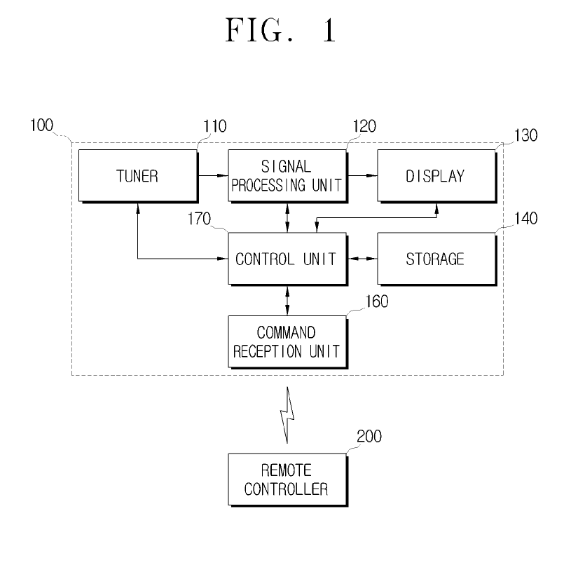

FIG. 1 is a block diagram illustrating a broadcast receiving apparatus according to an exemplary embodiment of the present invention.

Referring to FIG. 1, a broadcast receiving apparatus 100 may comprise a tuner 110, a signal processing unit 120, a display 130, a storage 140, a command reception unit 160, and a control unit 170.

The tuner 110 tunes to a broadcast signal received through terrestrial wave, cable, and satellite, processes the tuned broadcast signal in a manner of demodulation and error correction, and outputs the processed broadcast signal. The tuner 110 tunes to a broadcast signal having a frequency band corresponding to a control signal of the control unit 170, which will be explained below.

The signal processing unit 120 separates the tuned broadcast signal into video data, audio data, and additional data, and decodes the respective data. The signal processing unit 120 processes video data to meet the requirements of the display 130, including the vertical frequency, resolution, and aspect ratio.

The display 130 displays the video data processed by the signal processing unit 120 on a screen, and may be implemented as various types of display modules such as digital light process (DLP), liquid crystal display (LCD), or plasma display panel (PDP).

The storage 140 stores various programs required to perform the operation of the broadcast receiving apparatus 100, and setting a state of the broadcast receiving apparatus 100 which a user inputs. The storage 140 may store a table which is used to set an interval of channel selection required to scan channels. A channel selection interval is predetermined and stored in Table 1 in connection with the duration of time in which a key signal of the scan key is received, that is, the duration of time in which a user depresses the scan key.

TABLE 1

| Time | channel interval |
|---|---|
| 2 sec | 3 |
| 3 sec | 5 |
| . . . | . . . |

Alternatively, the last digit of the channel numbers is predetermined and stored in Table 2 in connection with the duration of time in which a key signal of the scan key is received, that is, the duration of time in which a user depresses the scan key.

TABLE 2

| Time | last digit of channel numbers |
|---|---|
| 2 sec | 1 |
| 3 sec | 2 |
| . . . | . . . |

The command reception unit 160 may comprise keys for receiving a user command and an infrared reception unit for receiving a signal transmitted from the remote controller 200, and transmits to the control unit 170 a key signal corresponding to the user command.

If a user inputs a command through the command reception unit 160, the control unit 170 controls components to carry out corresponding functions. The control unit 170 may be embodied as a microcomputer or a central processing unit (CPU). If a key signal corresponding to the scan key is received through the command reception unit 160, the control unit 170 counts the time in which a key signal of the scan key is received, that is, the time in which a user depresses the scan key to set a channel interval. The control unit 170 may set a channel selection interval with reference to a table stored in the storage 140.

The control unit 170 comprises an on screen display (OSD) generator (not shown). If a user depresses the scan key of the remote controller 200 for two seconds, the OSD generator generates an OSD menu to display the corresponding time on a screen.

The control unit 170 sets a channel interval to be 3 with reference to Table 1 stored in the storage 140, and thus scans channels in the sequence of channel numbers 10, 13, 16, etc. after current channel 7. Alternatively, the control unit 170 sets the last digit of the channel numbers to be 1 with reference to Table 2 stored in the storage 140, and scans channels in the sequence of channel numbers 11, 21, 31, 41, etc. after current channel 7.

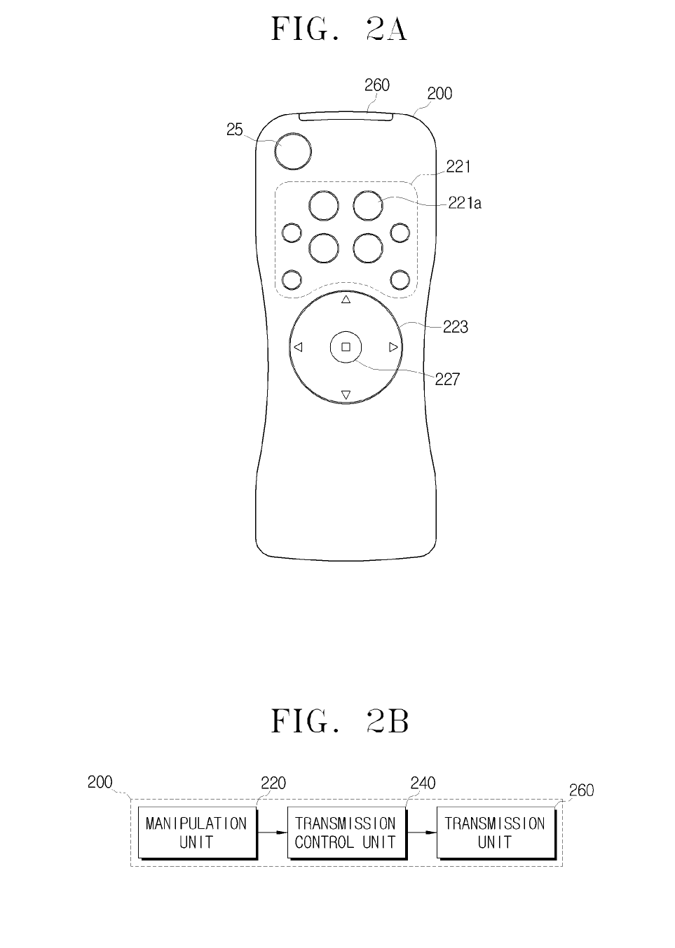

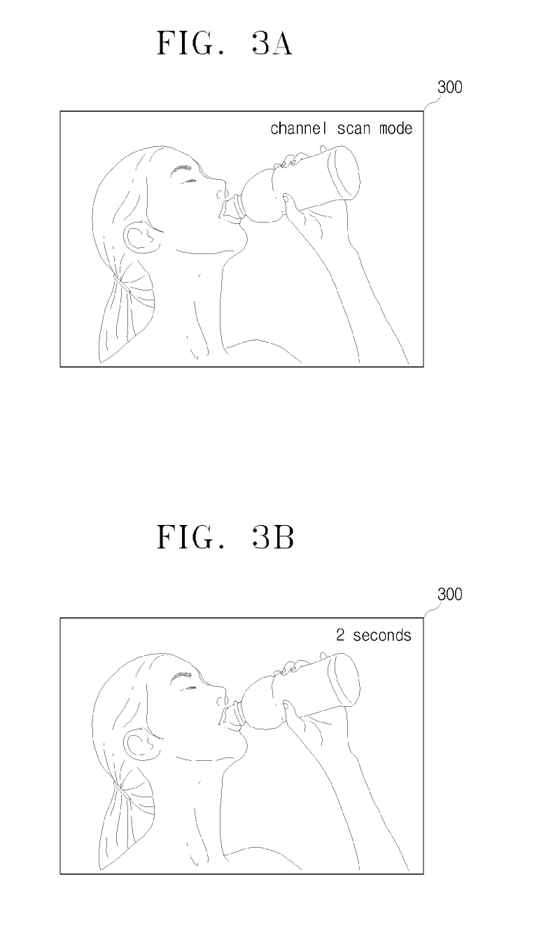

The operation for scanning channels will be explained below with reference to FIGS. 2A, 2B, 3A and 3B.

FIG. 2A is a view illustrating a remote controller according to an exemplary embodiment of the present invention. FIG. 2B is a block diagram illustrating an inner structure of a remote controller according to an exemplary embodiment of the present invention. FIGS. 3A and 3B are views illustrating a message displayed on a broadcast receiving apparatus according to an exemplary embodiment of the present invention.

Referring to FIG. 2A, the remote controller 200 according to an exemplary embodiment of the present invention employs function keys 221, 223, 225, 227, and does not employ numeric keys. That is, the remote controller 200 includes menu keys 221 for accessing various menus, direction keys 223 for adjusting channel and volume, power key 225 for turning on and off the broadcast receiving apparatus 100, and OK key 227. A user uses the plurality of function keys 221, 223, 225, 227 to control the operation of the broadcast receiving apparatus 100.

A scan key 221a of the remote controller 200 is provided to scan the channels of the broadcast receiving apparatus 100. If a user presses the scan key 221a one time, the broadcast receiving apparatus 100 enters into a channel scan mode. A screen 300 displays a message for informing that the broadcast receiving apparatus 100 enters into the channel scan mode as shown in FIG. 3A.

The scan key 221a adjacent to the menu keys 221 is located between the power key 225 and the direction key 223 as illustrated in FIG. 2A.

Referring to FIG. 2B, the remote controller 200 according to the exemplary embodiment of the present invention may comprise a manipulation unit 220 composed of the plurality of function keys 221, 223, 225, 227, a transmission control unit 240, and a transmission unit 260.

The transmission unit 260 converts a signal corresponding to the manipulation of the keys 221, 223 of the manipulation unit 110 into infrared rays under the control of the transmission control unit 240, and transmits the infrared rays to the broadcast receiving apparatus 100.

If a user depresses the scan key 221 a for more than two seconds while the broadcast receiving apparatus 100 is in a channel scan mode, the duration of time for depressing the scan key 221a is displayed on the screen 300 as shown in FIG. 3B. If a user depresses one of the direction keys 223 when ‘two seconds’ is displayed on the screen 300, a channel interval may be set to 3 as shown in Table 1, and channels may be scanned in the sequence of current channel 7, and channels 10, 13, 16, etc., or in the sequence of current channel 7, and channels 4, 1, 98, etc. Alternatively, the last digit of the channel numbers may be set to 1 as shown in Table 2, and channels may be scanned in the sequence of current channel 7, and channels 11, 21, 31, 41, . . . , or in the sequence of current channel 7, and channels 91, 81, 71, . . . .

While FIG. 3B illustrates the screen 300 on which only the duration of time in which a user depresses the scan key 221a is displayed, a channel interval or the last digit of channel numbers may also be displayed on the screen 300.

If a user presses quickly the scan key 221a twice, the channel scan mode is finished.

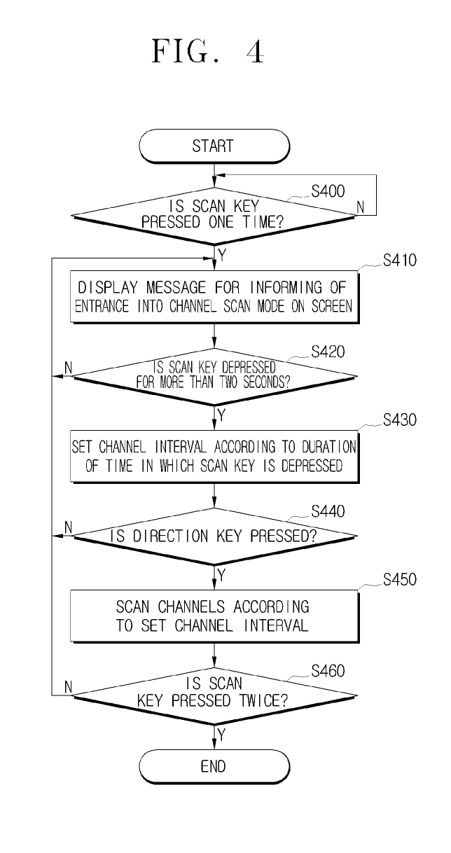

FIG. 4 is a flowchart provided to explain the operation of a broadcast receiving apparatus according to an exemplary embodiment of the present invention.

Referring to FIG. 4, if a user presses the scan key 221a of the remote controller 200 one time (S400—Y), the broadcast receiving apparatus 100 enters into a channel scan mode. The control unit 170 controls the display 130 to display a message for informing that the broadcast receiving apparatus 100 enters into the channel scan mode on a screen (S410).

If a user depresses the scan key 221a of the remote controller 200 for more than two seconds (S420—Y), the control unit 170 sets a channel interval according to the duration of time in which the scan key 221a is depressed (S430). That is, the control unit 170 sets a channel interval or the last digit of the channel numbers to correspond to the duration of time in which the scan key 221a is depressed, with reference to a table stored in the storage 140.

If a user presses one of the direction keys 223 on the remote controller 200 (S440—Y), the control unit 170 controls the broadcast receiving apparatus 100 to scan channels according to a set channel interval (S450). If a user presses the direction key ▴, channel numbers are scanned in an ascending sequence, and if a user presses the direction key ▾, channel numbers are scanned in a descending sequence.

If a user presses quickly the scan key 221a of the remote controller 200 twice (S460—Y), the channel scan mode is finished.

If a user does not depress the scan key 221a in operation S420 (S420—N), does not depress one of the direction keys 223 in operation S40 (S440—N), or does not presses the scan key 221a twice in operation S460 (S460—N), the control unit 170 performs operation S410.

A user can select a desired channel by performing the above operations in the channel scan mode.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A broadcast receiving apparatus, comprising:
a reception unit which receives a user command transmitted from a remote controller composed exclusively of a plurality of function keys; and
a control unit which counts a time period in which a key signal corresponding to a predetermined key of the function keys is received through the reception unit, and scans channels based on the counted time period.

2. The apparatus of claim 1, wherein the control unit sets a digit corresponding to the counted time period to be a channel scan interval to scan the channels.

3. The apparatus of claim 1, wherein the control unit searches the channels each having a last digit corresponding to the counted time period.

4. The apparatus of claim 1, further comprising:
an on screen display (OSD) generator which generates an OSD menu to display the time period in which the key signal is received through the reception unit.

5. The apparatus of claim 1, wherein the predetermined key is a scan key to receive a channel scan command.

6. The apparatus of claim 1, wherein the control unit counts the time period in which the key signal is received through the reception unit, and if a predetermined command is input through the remote controller, scans the channels according to the counted time period.

7. A method for scanning channels, comprising:
receiving a key signal corresponding to a predetermined key from a remote controller composed exclusively of a plurality of function keys; and
counting a time period in which the key signal is received, and scanning the channels based on the counted time period.

8. The method of claim 7, wherein the scanning the channels further comprises:
setting a digit corresponding to the counted time period to be the channel scan interval to scan the channels.

9. The method of claim 7, wherein the scanning the channels further comprises:
searching channels having a last digit corresponding to the counted time period.

10. The method of claim 7, further comprising:
displaying one of the time period in which the key signal is received, and a digit corresponding to the time period in which the key signal is received.

11. The method of claim 7, further comprising:
storing a table which is used to search the channels,
wherein the digit corresponding to the counted time period is stored in the table, corresponding to the channel scan interval to search the channels or the last digit of channel numbers to be searched.

12. The method of claim 7, wherein the predetermined key is a scan key to receive a channel scan command.

13. The method of claim 7, further comprising:
scanning the channels, if a predetermined command is input through the remote controller.

14. The method of claim 13, wherein the scanning the channels further comprises;
scanning the channels in an ascending sequence according to the channel scan interval if the predetermined command is input through an up key of the remote controller; and
scanning the channels in a descending sequence according to the channel scan interval if the predetermined command is input through a down key of the remote controller.

15. A method for scanning channels of a broadcast receiving apparatus using a remote control having no numeric key, the method comprising:
counting a time period in which a predetermined key is depressed; and
selecting a channel to be changed according to a digit corresponding to the counted time period.

16. The method of claim 15, wherein the selecting the channel comprises:
selecting a channel to be changed, if the channel is above or under a current channel by an interval based on the digit corresponding to the counted time period.

17. The method of claim 15, wherein the selecting the channel comprises:
selecting a channel to be changed, among channels from which a broadcast signal is detected, if the channel is above or under a current channel by an interval based on the digit corresponding to the counted time period.

18. The method of claim 15, wherein the selecting the channel comprises:
selecting a channel to be changed, if the channel is a last digit that corresponds to the counted time period, and is the nearest channel to the current channel.

19. The method of claim 15, wherein if the predetermined key is pressed twice, the channel scan mode is completed.

20. A method for scanning channels, comprising:
receiving a key signal from a remote controller; and
counting a time period in which the key signal is received, and scanning the channels based on the counted period.
